(19) United States
(12) Patent Application Publication
(10) Pub. No.: US 2013/0148281 A1
(43) Pub. Date: Jun. 13, 2013

(54) POWER SWITCH AND COMPUTER CASE

(71) Applicant: ZE-LIANG XIE, Shenzhen City (CN)

(72) Inventor: ZE-LIANG XIE, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/495,666

(22) Filed: Jun. 13, 2012

(30) Foreign Application Priority Data
Dec. 9, 2011 (CN) 201110408569.8

(51) Int. Cl. H01H 13/04; G06F 1/16

(52) U.S. Cl. 361/679.02; 200/293

(57) ABSTRACT

A power switch is used for protection against static electricity and includes a main body, a metal pin and a protection section. The metal pin and the protection section are positioned on the same side of the main body. The main body and the protection section are made of insulating material. The metal pin passes through the protection section and is partially received within the protection section, and the other part of the metal pin is exposed.

### BACKGROUND

1. Technical field

The disclosure generally relates to power switches, particularly to a power switch with anti-static function and a computer case employing the anti-static function.

2. Description of the Related Art

Power switches are often used in different electronic devices such as computers and servers, and each power switch usually has two or more metal pins. The metal pins are electrically connected to a circuit board of the electronic device by wires or a socket. However, if the metal pins of the power switch cannot be fully inserted into the socket, one part of each metal pin may remain out of the socket and exposed to the air. Thus, static charges on the external surface of the electronic device may be conducted to the circuit board through the metal pins and the wires or socket, which may damage the circuitry on the circuit board.

Therefore, there is room for improvement within the art.

### BRIEF DESCRIPTION OF THE DRAWINGS

Many aspects of a power switch and computer case employing the same can be better understood with reference to the following drawings. The components in the drawings are not necessarily drawn to scale, the emphasis instead being placed upon clearly illustrating the principles of the power switch and computer case employing the same. Moreover, in the drawings, like reference numerals designate corresponding parts throughout the several views. Wherever possible, the same reference numbers are used throughout the drawings to refer to the same or like elements of an embodiment.

FIG. 1 is a schematic view of an exemplary embodiment of a power switch of the disclosure.

FIG. 2 is similar to FIG. 1, but shown from another angle.

FIG. 3 is a schematic view of an exemplary embodiment of a computer case including the power switch of the disclosure.

FIG. 4 is similar to FIG. 3, but shown from another angle.

### DETAILED DESCRIPTION

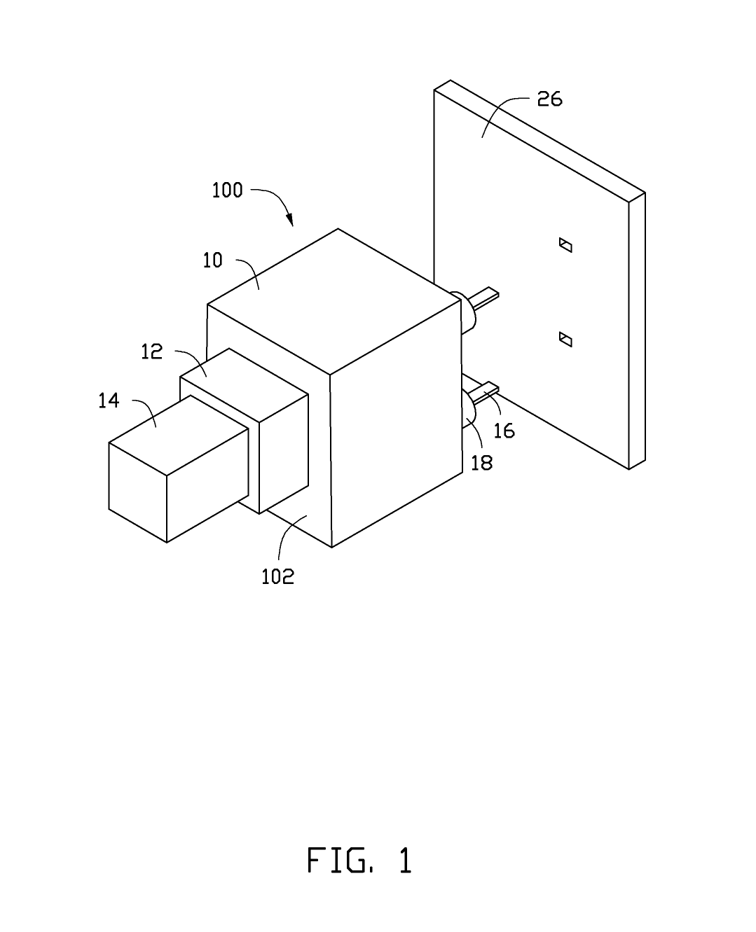

FIG. 1 is a schematic view of an exemplary embodiment of a power switch 100 of the disclosure. In the exemplary embodiment, the power switch 100 includes a main body 10, a connection section 12, an operation section 14, two metal pins 16, and two protection sections 18. The main body 10, the connection section 12, the operation section 14 and the two protection sections 18 are made of insulating material. In the exemplary embodiment, the number of the metal pins 16 can be one or more than two.

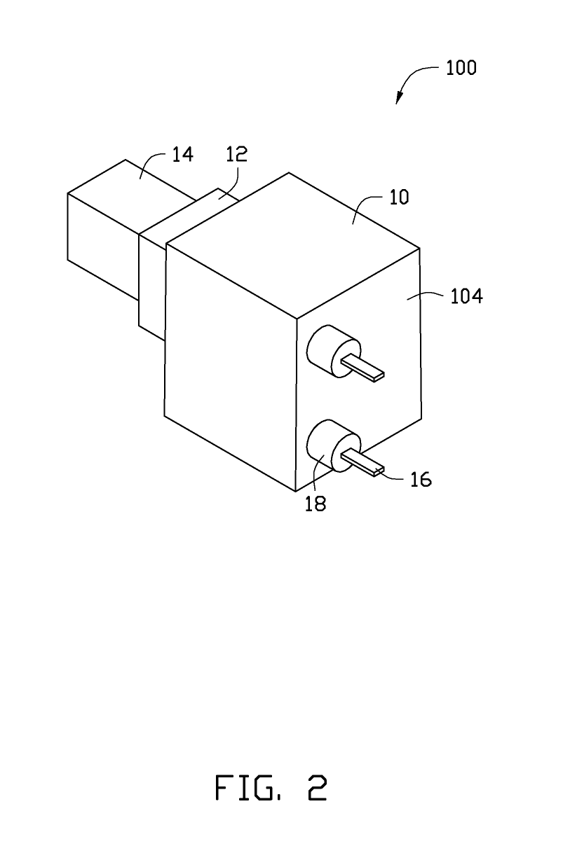

FIG. 2, illustrates the main body 10 in the exemplary embodiment. The main body 10 has a substantially rectangular shape and includes a first surface 102 and a second surface 104 opposite to the first surface 102. The connection section 12 is a rectangular body and is positioned generally near the center of the first surface 102. The size of the connection section 12 is smaller than the size of the main body 10.

The operation section 14 is a rectangular block. Smaller in size than the connection section 12, the operation section 14 may be received within the connection section 12 and can be perpendicularly removed relative to the connection section 12. In the exemplary embodiment, the operation section 14 includes a push-button switch (not shown), which makes contact when the button is pressed and breaks the connection when the button is released. For example, when the operation section 14 is pressed, the push-button switch contacts with the metal pins 16; when the operation section 14 is released, the push-button switch breaks contact with the metal pins 16.

The two metal pins 16 are supported by the second surface 104 of the main body 10 to electrically connect to a socket 26 or wires of an electronic device such as a server or computer. When the metal pins 16 electrically connect to the socket 26, the power switch 100 is electrically connected to an electronic device such as a server or computer.

Each of the protection sections 18 has a hollow cylindrical shape with a corresponding metal pin 16 protruding from the second surface 104. The metal pins 16 each passes through a corresponding protection section 18, leaving part of the metal pin 16 adjacent to the second surface 104 covered by the protection section 18 and the other part of the metal pin 16 exposed to contact the socket 26. The two protection sections 18 and the main body 10 are integrally molded.

When the metal pins 16 are inserted into the socket 26 of the electronic device, part of the metal pin 16 exposed from the protection section 18 electrically connects to the socket 26 of the electronic device, and the other part of the metal pin 16 is surrounded by the protection section 18 and cannot be directly exposed to the air. Thus, static charges, built up on the surface of the electronic device cannot be conducted to the inner circuitry of the electronic device through the metal pins 16.

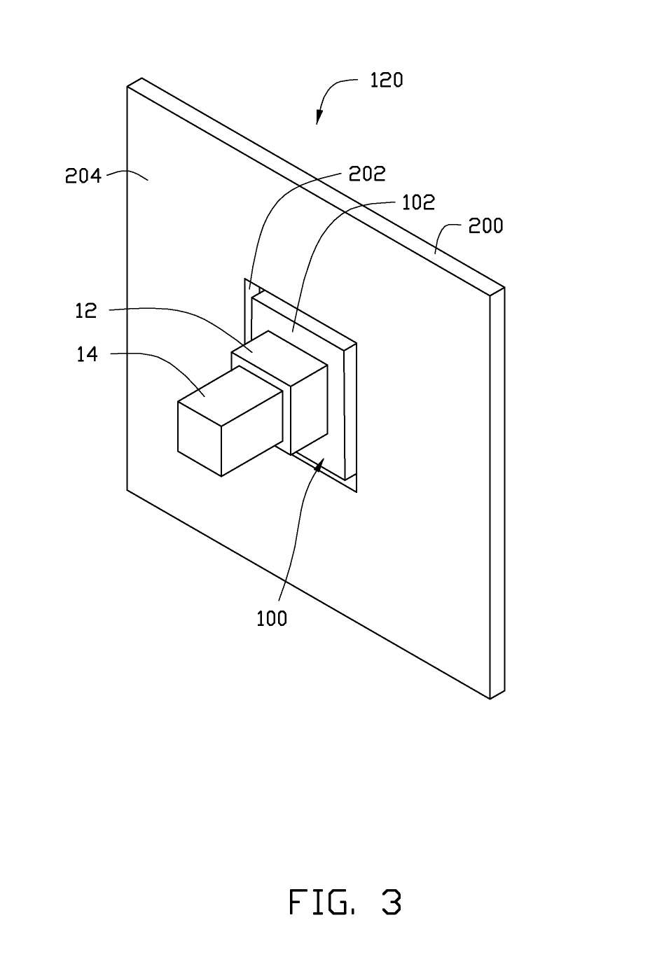

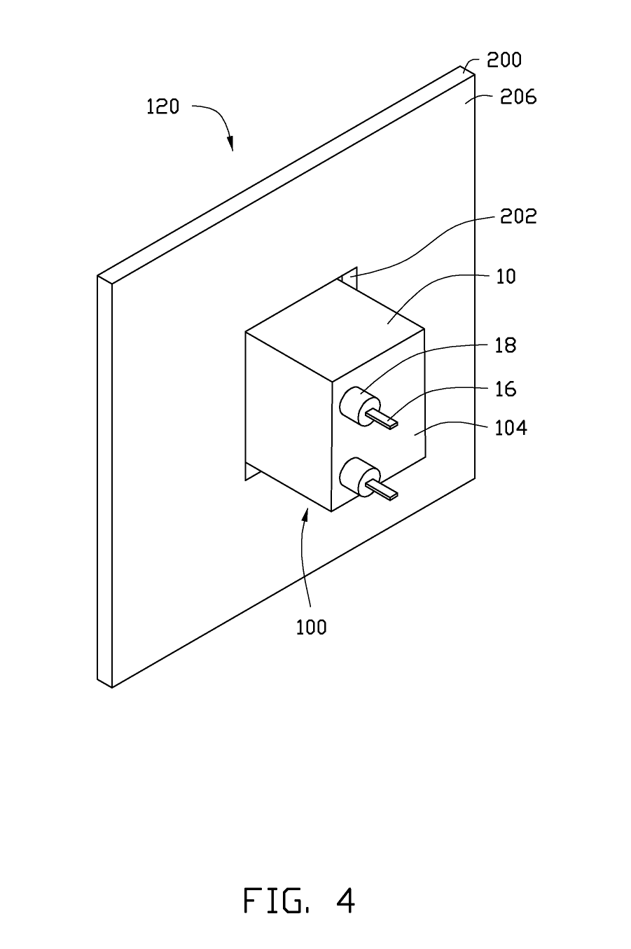

FIG. 3 is a schematic view of an exemplary embodiment of a computer case 120. The computer case 120 includes the power switch 100. In the exemplary embodiment, the computer case 120 further includes a mounting plate 200. Referring to FIG. 4, the mounting plate 200 includes an outer surface 204 and an inner surface 206. An opening 202 is defined on the mounting plate 200 and passes through the outer surface 204 and the inner surface 206.

When the power switch 100 is received within the opening 202, the first surface 102 of the main body 10 and the outer surface 204 are in the same plane. The metal pins 16, the protection sections 18 and the main body 10 pass through the opening 202 and are received within the computer case 120. The mounting plate 200 is made of metal, such as aluminium alloy.

In the exemplary embodiment, the outer surface 204 is coated with conformal coating material or other insulating materials, which acts as protection against static electricity that could result in damage or failure of the electronic device to function. The static charges on the inner surface 206 of the mounting plate 206 can be conducted to ground, thus avoiding damage to inner circuitry and electronic components within the computer case 120. Thus, the mounting plate 200 can isolate the static charges on the outer surface 204 and conduct the static charges on the inner surface 206 to ground.

In the power switch 100 of the disclosure, part of each metal pin 16 adjacent to the main body 10 is covered by the protection section 18, and the other part of each metal pin 16 is fully inserted into the socket 26 in the computer case 120, so the metal pins 16 cannot be exposed to the air. Thus, the static charges on the surface of the electronic device cannot be conducted to the inner circuitry of the electronic device through the metal pins 16. Moreover, since the outer surface 204 of the mounting plate 200 is coated with conformal coating material, the static charges on the outer surface 204 are isolated to protect against static electricity. The static charges on the inner surface 206 are conducted to ground, thus protecting the inner circuitry from damage.

In the present specification and claims, the word “a” or “an” preceding an element does not exclude the presence of a plurality of such elements. Further, the word “comprising” does not exclude the presence of elements or steps other than those listed.

It is to be understood, however, that even though numerous characteristics and advantages of the exemplary disclosure have been set forth in the foregoing description, together with details of the structure and function of the exemplary disclosure, the disclosure is illustrative only, and changes may be made in detail, especially in the matters of shape, size, and arrangement of parts within the principles of this exemplary disclosure to the full extent indicated by the broad general meaning of the terms in which the appended claims are expressed.

What is claimed is:

1. A power switch for protecting against static electricity comprising:
a main body;
a metal pin positioned on the main body; and
a protection section protruding from the main body;
wherein the main body and the protection section are made of insulating material, the metal pin passes through the protection section, one part of the metal pin is received within the protection section, and the other part of the metal pin is exposed.

2. The power switch as claimed in claim 1, wherein the main body comprises a first surface and a second surface opposite to the first surface, and the protection section and the metal pin are positioned on the second surface.

3. The power switch as claimed in claim 2, further comprising a connection section and an operation section, wherein the connection section is positioned near the center of the first surface, the operation section is received within the connection section and is removed relative to the connection section.

4. The power switch as claimed in claim 1, wherein the protection section and the main body are integrally molded.

5. A computer case comprising:
a mounting plate defining an opening; and
a power switch positioning on the mounting plate, the power switch comprising:
a main body received within the opening;
a metal pin positioned on one side of the main body; and
a protection section positioned on the side of the main body, wherein the main body and the protection section are made of insulating material, the metal pin passes through the protection section and is partially exposed from the protection section, and the other part of the metal pin is received within the protection section to isolate static electricity.

6. The computer case as claimed in claim 5, wherein the main body comprises a first surface and a second surface opposite to the first surface, and the protection section and the metal pin are positioned on the second surface.

7. The computer case as claimed in claim 6, wherein the power switch further comprises a connection section and an operation section, the connection section is positioned near the center of the first surface, the operation section is received within the connection section and is removed relative to the connection section.

8. The computer case as claimed in claim 6, wherein the mounting plate comprises an outer surface and an inner surface, the opening passes through the outer surface and the inner surface, and when the power switch is received within the opening, the first surface of the main body and the outer surface are in the same plane.

9. The computer case as claimed in claim 9, wherein the mounting plate is made of metal, the outer surface of the mounting plate is coated with any of conformal coating material and insulating material to protect against static electricity.

10. The computer case as claimed in claim 9, wherein the static charges on the inner surface of the mounting plate are conducted to ground to avoid damage to inner circuitry within the computer case, and the mounting plate is configured to isolate static charges on the outer surface and conduct the static charges on the inner surface to ground.

11. The computer case as claimed in claim 5, wherein the protection section and the main body are integrally molded.

12. A power switch for protecting against static electricity comprising:
a main body;
two metal pins positioned on the main body; and
two protection sections protruding from the main body;
wherein the main body and the protection sections are made of insulating material and each of the metal pins is partially received within a corresponding protection section.

13. The power switch as claimed in claim 12, wherein the main body comprises a first surface and a second surface opposite to the first surface, and the protection sections and the metal pins are positioned on the second surface.

14. The power switch as claimed in claim 13, further comprising a connection section and an operation section, wherein the connection section is positioned near the center of the first surface, the operation section is received within the connection section and is removed relative to the connection section.

15. The power switch as claimed in claim 12, wherein the protection sections and the main body are integrally molded.
